(19) United States
(12) Patent Application Publication
(10) Pub. No.: US 2008/0147596 A1
(43) Pub. Date: Jun. 19, 2008

(54) METHOD AND SYSTEM FOR IMPROVING SQL DATABASE QUERY PERFORMANCE

(76) Inventors: William McKenna, Oceanside, CA (US); Ahmad Ghazal, Redondo Beach, CA (US)

Correspondence Address: JAMES M. STOVER;TERADATA CORPORATION, 2835 MIAMI VILLAGE DRIVE, MIAMISBURG, OH, 45342, US

(21) Appl. No.: 11/612,005

(22) Filed: Dec. 18, 2006

(51) Int. Cl. G06F 17/30; G06F 7/00

(52) U.S. Cl. 707/2; 707/4; 707/E17.017; 707/E17.045

(57) ABSTRACT

Methods and systems for rewriting database queries, and in particular databases using Structured Query Language (SQL). The method comprises the steps of reviewing a SQL query statement having a SELECT list to determine if a view definition of the query has one or more unreferenced view columns; and removing at least one of the one or more unreferenced view columns from the view definition. The step of removing at least one of the one or more unreferenced view columns may also include removing all of the one or more unreferenced view columns from the view definition. This method improves performance of a query given that the spool file generated by the query rule contains minimal amount of data necessary for the query to be processed.

### TECHNICAL FIELD

The present invention relates to methods and systems for rewriting database queries, and in particular databases using Structured Query Language (SQL).

### BACKGROUND ART

Relational database management systems (RDBMSs) store data in tables organised by columns and rows. The tables typically are linked together by “relationships” that simplify the storage of the data and make complex queries against the database more efficient. SQL is a standardised language for creating and operating on relational databases. An example of a SQL program product is “TERADATA” (RTM) owned by NCR Corporation.

To improve the efficiency of SQL queries, several methods have been devised to “rewrite” the query. Such rewriting is known as Query Rewriting (QRW). Examples of QRW include join elimination, transitive closure, predicate move around, join index usage and view folding. Views, or derived tables (referred to collectively as “views”) can appear in data manipulation statements submitted to the database management system (DBMS). When possible, to improve efficiency, a view's definition is “folded” into the query block referencing the view. “Folding” a view means the query block is rewritten without reference to the view. For example, applying view folding to the query:

SELECT t1.a1, DT.a2 FROM t1, (select a2 from t2) DT

WHERE t1.a1=DT.a2

produces the query:

SELECT t1.a1, t2.a2 from t1, t2 WHERE t1.a1=t2.a2

However, it is not always possible to fold a query. For example, it is not possible to fold a view definition when the view result needs to be materialised prior to processing the containing block. For example, if the definition of DT in the previous query was “SELECT MAX(a2)a2, SUM(b2)b2 FROM t2” then the rows of DT must be materialised into a spool before the join with t1.

### SUMMARY OF THE INVENTION

According to a first aspect of the invention there is provided a method for rewriting a SQL query statement having a SELECT list, the method comprising the following steps:

reviewing the statement to determine if a view definition of the query has one or more unreferenced view columns; and

removing at least one of the one or more unreferenced view columns from the view definition.

This improves performance of the query given that the spool file generated by the query rule contains minimal amount of data necessary for the query to be processed.

Optionally the step of removing at least one of the one or more unreferenced view columns comprises removing all of the one or more unreferenced view columns from the view definition.

The method may further comprise the step, after the step of removing the at least one of the one or more unreferenced view columns, of rewriting the query without reference to the view.

Optionally, if the removal of the at least one of the one or more unreferenced view columns would change the number of rows produced by the view definition, the step of removing the at least one column is not performed.

Optionally, the query has a containing block and wherein when no view columns are referenced by the containing block, the query's SELECT list is changed to “sel 0”.

Optionally, the query has a containing block and wherein when the query would return a single row view and no columns of the single row view are referenced, the query is changed to “sel 0”.

The above described method can be performed on a computer.

According to another aspect of the invention there is provided a computer program, stored on a tangible medium, for use in rewriting a SQL query statement having a SELECT list, the program comprising executable instructions that cause a computer to perform the following steps:

reviewing the statement to determine if a view definition of the query has one or more unreferenced view columns; and

removing at least one of the one or more unreferenced view columns from the view definition.

Optionally, the step of removing at least one of the one or more unreferenced view columns comprises removing all of the one or more unreferenced view columns from the query statement.

Optionally, the program is configured to perform a step, after the step of removing the at least one of the one or more unreferenced view columns, of rewriting the query without reference to the view.

Optionally, if the removal of the at least one of the one or more unreferenced view columns would change the number of rows produced by the view, the step of removing the at least one column is not performed.

Further optionally, if the removal of the at least one of the one or more unreferenced view columns would result in the SELECT list having no expressions, the step of removing the at least one unreferenced view column is not performed.

Optionally, the query has a containing block and wherein when no view columns are referenced by the containing block, the query's SELECT list is reduced to “sel 0”.

Optionally, the query has a containing block and wherein when the query would return a single row view and no columns of the single row view are referenced, the query is changed to “sel 0”.

According to another aspect of the invention there is provided a method for rewriting a SQL query statement having a SELECT list and one or more unreferenced view columns, the method comprising the step of removing at least one of the one or more unreferenced view columns from the query prior to running the query.

In the preceding and following paragraphs, and in the claims, all references to “sel 0” means that SELECT returns a single row with a single column whose value is

### BRIEF DESCRIPTION OF THE DRAWINGS

Preferred embodiments of the invention will now be described, by way of example only, with reference to the examples and to the accompanying drawing in which:

FIG. 1 is a flow diagram illustrating steps of a preferred method embodiment; and

FIG. 2 is a schematic view of an embodiment of a computer system for performing an embodiment of the method of the present invention.

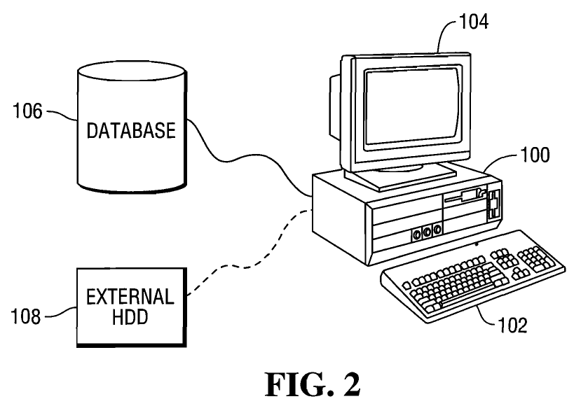

### DETAILED DESCRIPTION OF THE PREFERRED EMBODIMENTS

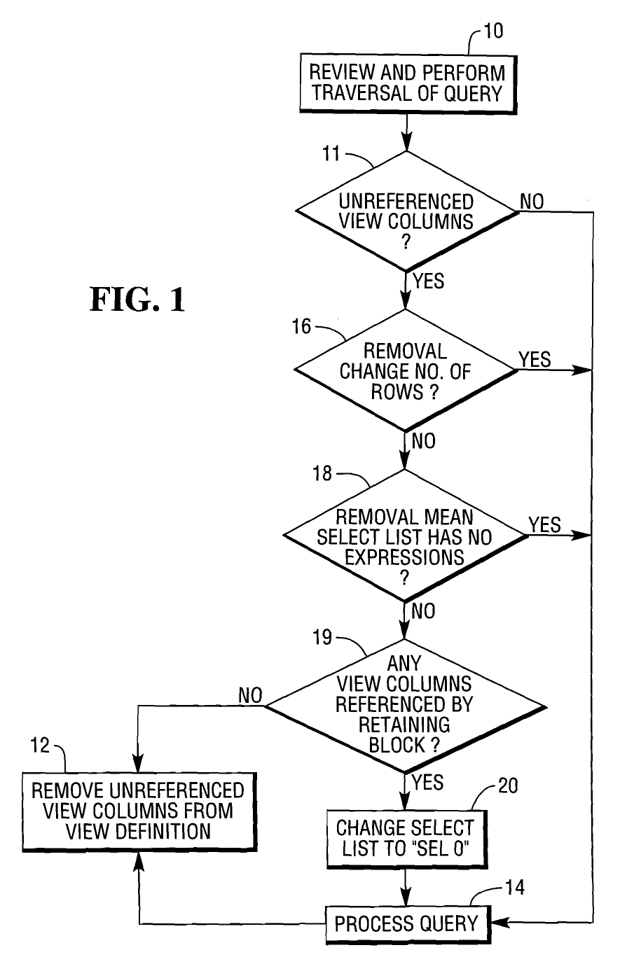

A preferred embodiment is a method for rewriting a SQL query statement having a SELECT list. The steps of the embodiment are represented by the flow diagram in FIG. 1. For performance reasons a spool file should contain the minimal amount of data necessary to process the query. (For example, the above referenced TERADATA (RTM) RDBMS currently applies data compression to spool columns to help reduce spool file size). The preferred embodiment is proposed for use on the TERADATA (RTM) RDBMS, however it is not limited to use on this SQL RDBMS and can be adapted for use on other SQL RDBMSs. The preferred embodiment reduces spooled view file sizes by removing unreferenced columns from the SELECT lists of view definitions. E.g. in the example above with respect to the prior art, where DT's SELECT list is “select max(a2) a2, sum(b2) b2”, the expression “sum(b2) b2” can safely be removed from the view definition since the containing query does not reference DT.b2. Doing so will reduce the size of the spool file and improve performance.

For convenience this removal of unreferenced view columns may be referred to as “pushing projections into views” (or simply “projection pushdown”) because the corresponding transformation in relational algebra involves pushing relational projection operations before other relational operators in a relational algebra expression. A relational projection operator specifies which columns of an input relation are produced by the projection operation for input to the projection's parent operation.

Pushing projection into views is one type of query rewrite (QRW) which may be used, for example in the above referenced TERADATA (RTM). Pushing projections into views can enable rewrites such as view folding and join elimination.

In the method, a step of reviewing the SQL query statement to determine if a view definition of a query has one or more referenced view columns is performed. In this embodiment, a basic algorithm is to perform a preordered traversal 10 of the statement (i.e. process each block before any block reachable from the block). For each view in a block we fmd all references to a view column in the containing block and check if the query has any unreferenced view columns 11. All of the one or more unreferenced view columns are then removed from the view definition 12 prior to processing the query, unless the removal of the at least one of the one or more unreferenced view columns would change the number of rows produced by the view definition 16, or if the removal of the at least one of the one or more unreferenced view columns would result in the SELECT lists having no expressions 18.

As noted above, in the prior art, spooled views contain all columns in the view definition's SELECT list even if the columns are not referenced by the containing query block or any subquery in the containing query block, as illustrated in Example 1.

### EXAMPLE 1

CREATE VIEW v1 (a, b, c) AS
SELECT a1, a2, SUM (a3)
FROM t1, t2, t3
WHERE b1=b2 AND c2=c3
GROUP BY a1, a2;
SELECT v1.a, v1.b
FROM v1, t4
WHERE v1.a=a4;

In the present embodiment, since v1.c is not referenced by the containing query block, “sum (a3)” can be removed from the SELECT list of the view definition for the execution of this query. This will reduce the size of the view spool file (if the view is spooled) and eliminate the unnecessary computation of the aggregate.

In Example 2, join elimination can be applied if the references to t1 are removed from the derived table's SELECT list (assuming the derived table is spooled).

### EXAMPLE 2

CREATE TABLE t1 (a1 INT NOT NULL, b1 INT, PRIMARY KEY (a1));
CREATE TABLE t2 (a2 INT, b2 INT, FOREIGN KEY (a2) REFERENCES t1);
SEL 1 FROM (SELECT * FROM t1,t2 WHERE a1=a2) dt;

The preferred embodiment can also allow views to be folded that would otherwise remain as spool files. For example, views containing CASE expressions are not merged in some cases. However, if these expressions are removed, view folding may take place.

For each view in a block we find all references (FieldRefs) to a view column in the current view. Any view column that is not referenced can be removed 12 from the view's SELECT list, unless the removal of the column would change the number of rows produced by the view 16 or result in the SELECT list having no expressions 18. Example 3 provides an illustration of this feature, using the definition of v1 from Example 1.

### EXAMPLE 3

CREATE TABLE t4 (a4 INT, b4 INT);
SELECT b4
FROM v1, t4;

Since no columns of v1 are referenced by the contaning block all expressions can be removed from the SELECT list and replaced with a single constant. The number of rows produced will be the same whether a GROUP BY clause is present or not.

In these cases where no view columns are referenced by the containing block 19, the view's SELECT list can be reduced to “sel 0” 20 to reduce the need to propagate columns across operators that evaluate the view. Furthermore, some views are guaranteed to return a single row, e.g., when the select list contains a single aggregate expression. These are called “single row” views. If no columns of a single row view are referenced, the view definition can be reduced to “sel 0;” 20 i.e., there is no table reference in the view. Example 4 is provided to illustrate this (where v1 is different to v1 of Example 1).

### EXAMPLE 4

CREATE VIEW v1 AS
SELECT MAX (a1) m
FROM t1;
SELECT a2
FROM t2, v1;

In this case, v1's view definition can be reduced to “sel 0”. Subsequent view folding 14 will remove the view completely from the query.

A special case is illustrated by the following query, using the definition of v1 from Example 4:

### EXAMPLE 5

SELECT COUNT(*) FROM v1;

In this case, the view definition can be reduced to “sel 0” but the view cannot be folded since an error would result (because the SQL “select count(*)” is invalid). The 1 row view would instead be spooled.

In the situation where nested view definitions are present, the preorder traversal guarantees that all unreferenced columns will be removed.

### EXAMPLE 6

CREATE VIEW v2(d, e) AS
SELECT v1.a,v1.b
FROM v1;
then for the query
SELECT v2.d
FROM v2, t4;

In Example 6, v1 is the same as v1 of Example 1. The preorder processing will ensure that a2 (as well as sum (a3)) are removed from v1's SELECT list since v1.b will be removed from v2's SELECT list before v1 is processed and this is the only reference to v1.b.

In the case where a join index can be used to process a view, the same join index can be used after projection pushdown is applied since the remaining view SELECT list columns will be a subset of the original view SELECT list.

The present embodiment can also be applied to UNION ALL inputs.

The main algorithm for the present embodiment is provided below. The input to the algorithm is the view subject to the optimization and its containing block.
PROCEDURE ProjViewNode(ViewBlock, ContainingBlock)
BEGIN
   1. If the view has distinct or a set operation that is not a UNION then return. Distinct views are single retrieves with distinct or set operations with distinct like UNION distinct, MINUS distinct or INTERESCT distinct.
   2. If view is a set operation call ProjViewNode recursively for each part using ContainingBlock as the outer block.
   3. For each field in the view

BEGIN
Check if field is referenced in ContainingBlock.
If it is not referenced remove it from the view definition.

END
4. Handle special case of views with empty fields (no reference in the ContainingBlock) including those that are single row views.
END.

The query string “ProjViewNode” is provided as a command to implement the preferred embodiment.

The special case in Example 5 above is handled by placing a constant like “0” in the select list of the view. If the view is a single row view (aggregations, no group by or having clauses) then it is completely simplified to “select 1”.

It will be appreciated that the above described embodiments can be implemented by a system of computer hardware and software. An embodiment of computer and other hardware which may implement the above described embodiments is illustrated in FIG. 1. FIG. 1 illustrates a computer 100 having a standard hardware configuration comprising a hard disk drive (HDD), bus, external data input means (for example a floppy disc drive, serial port, parallel port, USB port or firewire port) and central processing unit (CPU). Input means in the form of a computer keyboard and/or a mouse 102 is/are connected to the computer 100 to input information, and to instruct the CPU to execute a program loaded thereon. One such program is a program for executing SQL functions. A visual display unit (VDU) 104 is connected to the computer 100 to display information relating to the or each program being run on the computer 100. A database 106 containing information which is extracted and sorted by the SQL program and which can employ the above described SQL case construct embodiments is connected to the computer 100. Information may be input to the database via the keyboard 106 and/or loaded therein via a removable storage medium such as an external HDD 108, a USB flash memory storage device, or a 3.5″ floppy disk. The or another such removable storage medium may also be used to move an executable program, such as a SQL program or case construct as described above with respect to the preferred embodiments, onto the HDD of the computer 100 for later execution.

As will be understood, in alternative arrangements, the database may be contained on the HDD of the computer 100, or the computer 100 may be connected to the database 106 via a network, such as a local area network (LAN) or the internet. Alternatively, the computer 100 may also connect via a network to a server which runs, based on commands input to the computer 100 by a user via the keyboard 102, the SQL program and/or the case construct of the above described embodiments.

While the invention has been described in reference to its preferred embodiments, it is to be understood that the words which have been used are words of description rather than limitation and that changes may be made to the invention without departing from its scope as defined by the appended claims.

What is claimed is:

1. A method for rewriting a SQL query statement having a SELECT list, the method comprising the following steps:
reviewing the statement to determine if a view definition of the query has one or more unreferenced view columns; and
removing at least one of the one or more unreferenced view columns from the view definition.

2. The method of claim 1, wherein the step of removing at least one of the one or more unreferenced view columns comprises removing all of the one or more unreferenced view columns from the view definition.

3. The method of claim 1, comprising the step, after the step of removing the at least one of the one or more unreferenced view columns, of rewriting the query without reference to the view.

4. The method of claim 1, wherein if the removal of the at least one of the one or more unreferenced view columns would change the number of rows produced by the view definition, the step of removing the at least one column is not performed.

5. The method of claim 1, wherein the query has a containing block and wherein when no view columns are referenced by the containing block, the query's SELECT list is changed to “sel 0”, where “sel 0” returns a single row with a single column whose value is “0”.

6. The method of claim 1, wherein the query has a containing block and wherein when the query would return a single row view and no columns of the single row view are referenced, the query is changed to “sel 0”, where “sel 0” returns a single row with a single column whose value is “0”.

7. The method of claim 1 performed on a computer.

8. A computer program, stored on a tangible medium, for use in rewriting a SQL query statement having a SELECT list, the program comprising executable instructions that cause a computer to perform the following steps:
reviewing the statement to determine if a view definition of the query has one or more unreferenced view columns; and
removing at least one of the one or more unreferenced view columns from the view definition.

9. The computer program of claim 8, wherein the step of removing at least one of the one or more unreferenced view columns comprises removing all of the one or more unreferenced view columns from the query statement.

10. The computer program of claim 8, configured to perform a step, after the step of removing the at least one of the one or more unreferenced view columns, of rewriting the query without reference to the view.

11. The computer program of claim 8, wherein if the removal of the at least one of the one or more unreferenced view columns would change the number of rows produced by the view, the step of removing the at least one column is not performed.

12. The computer program of claim 8, wherein if the removal of the at least one of the one or more unreferenced view columns would result in the SELECT list having no expressions, the step of removing the at least one unreferenced view column is not performed.

13. The computer program of claim 8, wherein the query has a containing block and wherein when no view columns are referenced by the containing block, the query's SELECT list is reduced to “sel 0”, where “sel 0” returns a single row with a single column whose value is “0”.

14. The computer program of claim 8, wherein the query has a containing block and wherein when the query would return a single row view and no columns of the single row view are referenced, the query is changed to “sel 0”, where “sel 0” returns a single row with a single column whose value is “0”.

15. A method for rewriting a SQL query statement having a SELECT list and one or more unreferenced view columns, the method comprising the step of removing at least one of the one or more unreferenced view columns from the query prior to running the query.
